(19) United States
(12) Patent Application Publication
(10) Pub. No.: US 2016/0190543 A1
(43) Pub. Date: Jun. 30, 2016

(54) Safety Device of Lithium-ion Battery

(71) Applicant: Ningde Amperex Technology Limited, Ningde (CN)

(72) Inventors: Rulai CAI, Ningde (CN); Peng WANG, Ningde (CN); Pinghua DENG, Ningde (CN); Qiong QU, Ningde (CN); Peng YU, Ningde (CN)

(21) Appl. No.: 14/757,933

(22) Filed: Dec. 23, 2015

(30) Foreign Application Priority Data
Dec. 25, 2014 (CN) 201410819266.9

(51) Int. Cl. H01M 2/34; H01M 10/0525

(52) U.S. Cl. CPC H01M 2/345; H01M 10/0525; H01M 2200/20

(57) ABSTRACT

The present disclosure relates to a safety device of a lithium-ion battery comprising a cap plate, a first electrode post, a second electrode post, a deformable plate and a conductive piece, the first electrode post and the second electrode post are provided to the cap plate, the first electrode post is insulated from and assembled to the conductive piece, the deformable plate is provided between the first electrode and the conductive piece, and the deformable plate is electrically connected to the first electrode post and the conductive piece respectively, the conductive piece is provided with a recessed portion, the recessed portion is provided with a notch. The safety device of the lithium-ion battery ensures the recessed portion will be broken effectively by the internal pressure when an internal pressure of the lithium-ion battery reaches a preset value so as to disconnect the charging circuit and provide security protection.

### REFERENCE TO RELATED APPLICATIONS

The present application claims priority to Chinese patent application No. 201410819266.9, filed on Dec. 25, 2014, which is incorporated herein by reference in its entirety.

### FIELD OF THE PRESENT DISCLOSURE

The present disclosure belongs to a field of a lithium-ion battery technology, and specifically relates to a safety device of a lithium-ion battery.

### BACKGROUND OF THE PRESENT DISCLOSURE

With the development of modern society and people's awareness of environmental protection, electrical vehicles tend to widely use the lithium-ion battery as the energy source. Power batteries should not only have high capacity, but also have a good safety performance and a long cycle life. In order to ensure the safety performance of the power battery to a certain extent, a cap assembly of the power battery is generally provided with a vent, when the power battery is under a situation of abnormal use, such as improper charging, short-circuit, or exposure to high temperature environment, a high amount of energy is quickly gathered in the lithium-ion battery, the power battery with high energy will produce a large amount of gas and the temperature thereof will rise sharply, the gas bursts through the vent to release the pressure in the power battery. The existence of the vent improves the safety performance of the power battery to a certain extent, but if the high energy gathered in the power battery when the power battery is under a situation of abnormal use is not released, the power battery itself becomes a potential dangerous resource and there are still certain safety problems left, if the power battery continues to be overcharged when the power battery has been already under a situation of abnormal use, more serious safety problems will be caused.

In order to improve the safety performance of the lithium-ion battery, a safety device of the lithium-ion battery appears in the market, the safety device may disconnect the charging circuit when the lithium-ion battery is under a situation of abnormal use (i.e. overcharging) and stop charging the lithium-ion battery, so as to improve the safety performance of the lithium-ion battery. For example, a safety device of a lithium-ion battery with a deformable plate is disclosed in Chinese Patent Application No. CN201320886713.3, the deformable plate is deformed to flip due to a pressure difference, so as to disconnect the electrical connection of the charging circuit, and in turn avoid potential safety risk caused by overcharging. However, the deformable plate and the conductive piece are welded together, so it can not ensure to separate the deformable plate from the conductive piece under the pressure difference.

### SUMMARY OF THE PRESENT DISCLOSURE

In view of the problems in the background, an object of the present disclosure is to provide a safety device of a lithium-ion battery, the safety device can disconnect the charging circuit when the lithium-ion battery is under a situation of abnormal use, and stop charging the lithium-ion battery, so as to improve the safety performance of the lithium-ion battery.

In order to achieve the above object, the present disclosure provides a safety device of a lithium-ion battery comprising: a cap plate, a first electrode post, a second electrode post, a deformable plate and a conductive piece, the first electrode post and the second electrode post are provided to the cap plate, the first electrode post is insulated from and assembled to the conductive piece, the deformable plate is provided between the first electrode and the conductive piece, and the deformable plate is electrically connected to the first electrode post and the conductive piece, the conductive piece is provided with a recessed portion, the recessed portion is provided with a notch. The recessed portion is a weak location of the conductive piece, when an internal pressure of the lithium-ion battery reaches a preset value, the weak location (i.e. the recessed portion) of the conductive piece will be broken, that is, the notch provided to the recessed portion will make the conductive piece broken from the notch first when the internal pressure reaches the preset value, therefore the conductive piece can be broken under the internal pressure reaching the preset value and also the broken position of the conductive piece can be controlled within the region surrounded by the notch.

In an embodiment, the recessed portion is provided with a welding portion, the deformable plate is welded to the welding portion, the welding portion is provided within the region surrounded by the notch. Because the welding portion is provided within the region surrounded by the notch, the electrical connection between the deformable plate and the conductive piece is disconnected when the notch is broken, and in turn the charging circuit is disconnected, thereby avoiding overcharging and providing security protection.

In an embodiment, both sides of the conductive piece each are provided with the notch, the notches on the both sides are symmetrical relative to a plane where the conductive piece is present. The symmetrical notches on the both sides further ensure the conductive piece can be broken under the internal pressure reaching the preset value.

In an embodiment, a thickness of the recessed portion is 0.3 mm˜2 mm.

In an embodiment, a depth of the notch is 0.04 mm˜0.1 mm.

In an embodiment, the deformable plate and the welding portion may be welded and sealed together by laser penetration welding, which ensures the electrical connection between the deformable plate and the conductive piece and prevents the poor welding.

In an embodiment, a region surrounded by the notch is a rectangle, a circle, a sector, an ellipse, a trapezoid or a triangle in shape.

In an embodiment, the first electrode post is electrically connected to the cap plate by welding, riveting or circlip assembling.

In an embodiment, the conductive piece is a rectangle, a circle or an ellipse in shape.

The present disclosure has the following beneficial effects: the safety device of the lithium-ion battery is provided with the deformable plate and the conductive piece which are electrically connected with each other, the conductive piece is provided with the recessed portion and the recessed portion is provided with the notch, therefore the recessed portion can be broken effectively by the internal pressure when the internal pressure of the lithium-ion battery reaches the preset value so as to disconnect the charging circuit and provide security protection.

### BRIEF DESCRIPTION OF THE FIGURES

FIG. 1 is a schematic structural view of the present disclosure.

FIG. 2 is an enlarged view of a circle A of FIG. 1.

FIG. 3 is a view illustrating a state of a conductive piece broken in the position of the notch of the present disclosure.

FIG. 4 is a schematic structural view of the conductive piece provided with a notch on one side of the present disclosure.

FIG. 5 is a schematic structural view of the conductive piece provided with symmetrical notches on both sides of the present disclosure.

FIG. 6 is a schematic structural view of the deformable plate of the present disclosure.

Reference numerals of the embodiments are represented as follows:
1 cap plate
2 first electrode post
3 second electrode post
4 deformable plate
5 conductive piece
6 recessed portion
7 notch
8 welding portion.

### DETAILED DESCRIPTION

Hereinafter the present disclosure and the beneficial effects will be described in detail in combination with embodiments and the figures, but the present disclosure is not limited to these embodiments.

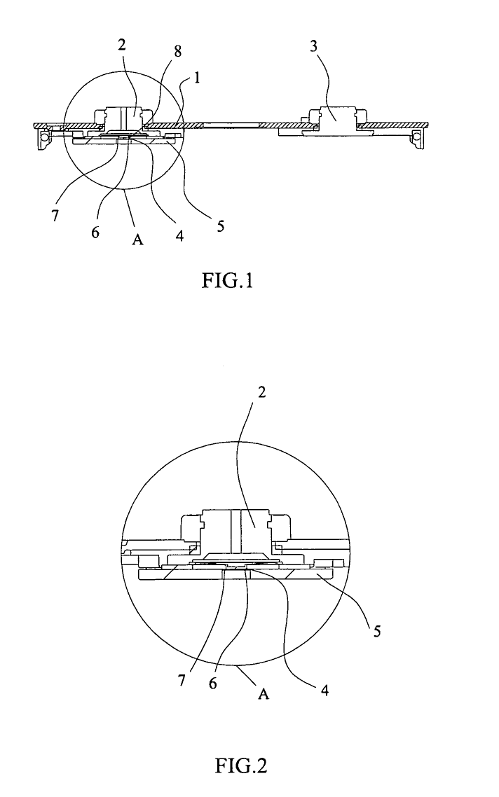

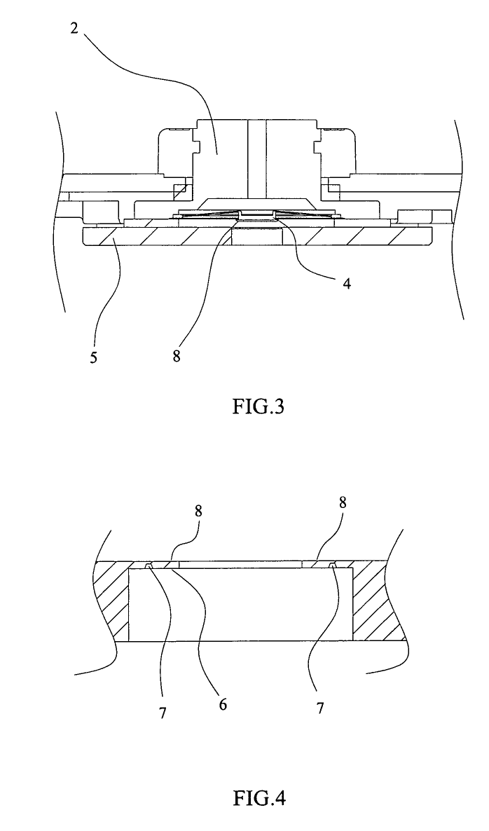

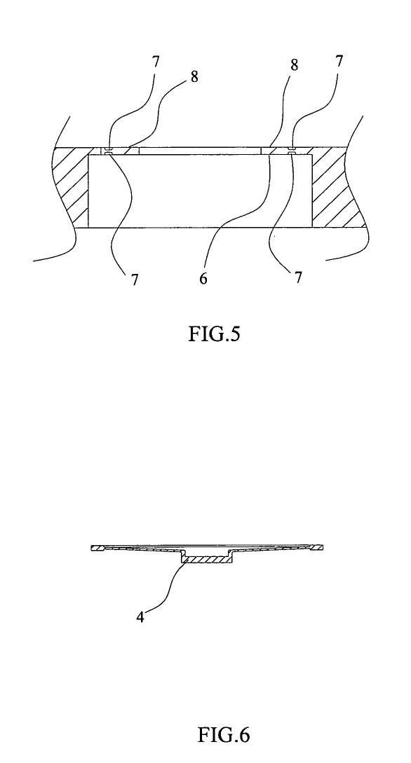

Referring to FIG. 1 to FIG. 6, a safety device of a lithium-ion battery comprises a cap plate 1, a first electrode post 2, a second electrode post 3, a deformable plate 4 and a conductive piece 5. The conductive piece 5 is a rectangle in shape, the first electrode post 2 and the second electrode post 3 are provided to the cap plate 1, the first electrode post 2 is insulated from and assembled to the conductive piece 5, the deformable plate 4 is provided between the first electrode post 2 and the conductive piece 5, and the deformable plate 4 is electrically connected to the first electrode post 2 and the conductive piece 5, the conductive piece 5 is provided with a recessed portion 6, a thickness of the recessed portion 6 is 1 mm, the recessed portion 6 is provided with a notch 7, a depth of the notch 7 is 0.03 mm, a region surrounded by the notch 7 is a rectangle in shape. The recessed portion 6 is provided with a welding portion 8, the deformable plate 4 and the welding portion 8 can be welded and sealed together by laser penetration welding, the welding portion 8 is provided within the region surrounded by the notch 7.

In an embodiment, both sides of the conductive piece 5 each are provided with the notch 7, the notches 7 on the both sides are symmetrical relative to a plane where the conductive piece 5 is present, and depths of the two notches 7 respectively on the both sides each are 0.03 mm.

In an embodiment, the thickness of the recessed portion 6 may be any value of 0.3 mm˜2 mm except 1 mm, the depth of the notch 7 may be any value of 0.04 mm˜0.1 mm.

In an embodiment, the region surrounded by the notch 7 may also be a circle, a sector, an ellipse, a trapezoid or a triangle in shape, the conductive piece 5 may also be a circle or an ellipse in shape.

In an embodiment, the first electrode post 2 is electrically connected to the cap plate 1 by welding, riveting or circlip assembling.

When the lithium-ion battery is under a situation of abnormal use, such as improper charging, short-circuit or exposure to high temperature environment, a high amount of energy is quickly gathered in the lithium-ion battery, the lithium-ion battery with high energy will produce a large amount of gas and the temperature thereof will rise sharply, which makes an internal pressure of the lithium-ion battery rise, when the internal pressure of the lithium-ion battery reaches a preset value of 0.3 MPa˜0.6 MPa, the conductive piece 5 will be broken in the position of the recessed portion 6, that is, the deformable plate 4 welded to the welding portion 8 is deformed (the deformable plate 4 will not be broken under a pressure value of 1 MPa), the region surrounded by the notch 7 of the conductive piece 5 will be broken along the notch 7, so as to disconnect the charging circuit of the lithium-ion battery and provide security protection. In other words, the deformable plate 4 can be instantaneously deformed to flip under the above preset pressure, so as to ensure the conductive piece 5 can be broken along the notch 7 and in turn disconnect the electrical connection between the deformable plate 4 and the conductive piece 5, the safety device of the lithium-ion battery according to the present disclosure can stop charging the lithium-ion battery when the lithium-ion battery is under a situation of abnormal use, and can eliminate safety risk caused by overcharging of the lithium-ion battery.

According to disclosing and teaching from the above description, those persons skilled in the art could devise various changes and modifications with respect to the embodiments. Therefore, the present disclosure is not limited to the above embodiments, any obvious modification, replacement or variation have been made based on the present disclosure by those skilled in the art, it will be fallen within the protection scope of the present disclosure. In addition, although some specific terminologies have been used in the explanation, these specific terminologies are just used for the convenience of explanation but do not constitute any limitation on the present disclosure.

What is claimed is:

1. A safety device of a lithium-ion battery, comprising:
a cap plate, a first electrode post, a second electrode post, a deformable plate and a conductive piece, the first electrode post and the second electrode post being provided to the cap plate, the first electrode post being insulated from and assembled to the conductive piece, the deformable plate being provided between the first electrode and the conductive piece, and the deformable plate being electrically connected to the first electrode post and the conductive piece, the conductive piece being provided with a recessed portion, the recessed portion being provided with a notch.

2. The safety device of the lithium-ion battery according to claim 1, wherein the recessed portion is provided with a welding portion, the deformable plate is welded to the welding portion, the welding portion is provided within a region surrounded by the notch.

3. The safety device of the lithium-ion battery according to claim 1, wherein both sides of the conductive piece each are provided with the notch, the notches on the both sides are symmetrical relative to a plane where the conductive piece is present.

4. The safety device of the lithium-ion battery according to claim 1, wherein a thickness of the recessed portion is 0.3 mm˜2 mm.

5. The safety device of the lithium-ion battery according to claim 1, wherein a depth of the notch is 0.04 mm˜0.1 mm.

6. The safety device of the lithium-ion battery according to claim 1, wherein the deformable plate and the welding portion are welded and sealed together by laser penetration welding.

7. The safety device of the lithium-ion battery according to claim 1, wherein a region surrounded by the notch is a rectangle, a circle, a sector, an ellipse, a trapezoid or a triangle in shape.

8. The safety device of the lithium-ion battery according to claim 1, wherein the first electrode post is electrically connected to the cap plate by welding, riveting or circlip assembling.

9. The safety device of the lithium-ion battery according to claim 1, wherein the conductive piece is a rectangle, a circle or an ellipse in shape.
